(19) United States
(12) Patent Application Publication
(10) Pub. No.: US 2009/0219710 A1
(43) Pub. Date: Sep. 3, 2009

(54) Wearable colored light signaling apparatus

(76) Inventor: Jason Ledderhos, Santa Clara, CA (US)

Correspondence Address: Jason Ledderhos, 827 Christopher Ct., Santa Clara, CA, 95051, US

(21) Appl. No.: 12/384,345

(22) Filed: Apr. 3, 2009

Related U.S. Application Data
(63) Continuation-in-part of application No. 11/510,458, filed on Aug. 28, 2006.

(51) Int. Cl. F21V 21/08

(52) U.S. Cl. 362/103

(57) ABSTRACT

The invention is a wearable array of colored lights that can be remotely controlled from a hand held user friendly interface. The user interface is made with interactive buttons for easy functional use. This allows manual control of each light independently. The embodiment can be adapted for use with other devices that are also worn or have user interfaces. The device of the present invention is operated by pressing the remote controller's interactive buttons to activate the remote colored light array. The remote colored light array is a small lightweight set of L.E.D. colored lights in an array that is worn around the ear.

Continuation in Part for patent application/control Ser. No. 11/510,458

### BACKGROUND-FIELD OF INVENTION

This invention relates to a remote controlled colored light array, specifically to a colored light array that is wearable and remotely controllable.

### BACKGROUND

Colored light arrays have been used for automotive traffic signaling. The traffic signals are big, power intensive, and are on preset pattern output. This invention is interactive in that the lights in the array can be manually controlled or modulated individually at the same time.

### SUMMARY

This invention relates to a wearable colored light array that is remotely controlled with a simple user interface that will allow manual interactive control of each light in the light array by the user wearing the light array.

### OBJECTS AND ADVANTAGES

Accordingly, several objects and advantages of the present invention are a small and light weight array of colored light emitting diodes (hereafter L.E.D. lights) that can be worn and remotely operated and interactively controlled by the user. This invention provides a simple user interface that allows remote manual interactive control over each L.E.D. light in the lightweight wearable colored light array. Each individual L.E.D. light in the colored light array can be manually modulated with the interactive controller.

### DESCRIPTION OF DRAWINGS

FIG. 1 is a general perspective of the apparatus showing a remote controller base, interactive buttons, battery terminal, connecting wire (hereafter patch cord), remote colored light array base, L.E.D. colored lights, and ear hook.

FIG. 2 shows a wiring diagram of the remote colored light array L.E.D. lights with the wiring jack.

FIG. 3 shows a wiring diagram of the remote controller interactive buttons, battery terminal, and wiring jack in the remote controller base.

### REFERENCE NUMERALS IN DRAWING

1 EAR HOOK
2 REMOTE COLORED LIGHT ARRAY BASE
3 BLUE L.E.D. LIGHT
4 ORANGE L.E.D. LIGHT
5 GREEN L.E.D. LIGHT
6 YELLOW L.E.D. LIGHT
7 RED L.E.D LIGHT
8 FEMALE WIRE JACK
9 MALE WIRE CONNECTOR
10 CONNECTING WIRE
11 MALE WIRE CONNECTOR
12 FEMALE WIRE JACK
13 REMOTE CONTROLLER BASE
14 BLUE L.E.D. LIGHT INTERACTIVE BUTTON
15 ORANGE L.E.D LIGHT INTERACTIVE BUTTON
16 GREEN L.E.D. LIGHT INTERACTIVE BUTTON
17 YELLOW L.E.D. LIGHT INTERACTIVE BUTTON
18 RED L.E.D. LIGHT INTERACTIVE BUTTON
19 BATTERY TERMINAL
20 CONNECTING SCREWS

### DESCRIPTION

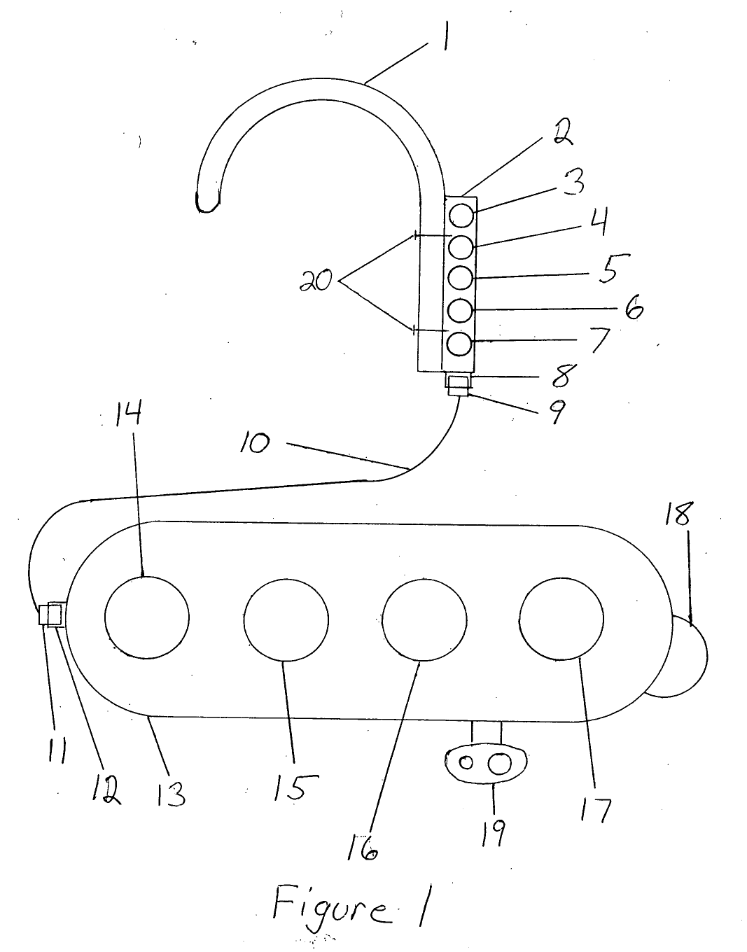

FIG. 1 shows the preferred embodiment of the present invention. A remote colored light array base 2 is used to hold colored L.E.D. lights 3, 4, 5, 6, and 7 in an array. An ear hook 1 is mounted onto the remote colored light array base 2 with connecting screws 20. A female wire jack is secured onto the remote colored light array base 2. A male wire connector 9 is plugged into the female wire jack 8. The male wire connector 9 is connected to a connecting wire 10. The other end of the connecting wire 10 is connected to a male wire connector 11. The male wire connector 11 is plugged into a female wire jack 12. The female wire jack 12 is secured onto a remote controller base 13. The remote controller base 13 is used to hold the interactive controller buttons 14, 15, 16, 17, and 18. A battery terminal 19 is secured onto the remote controller base 13.

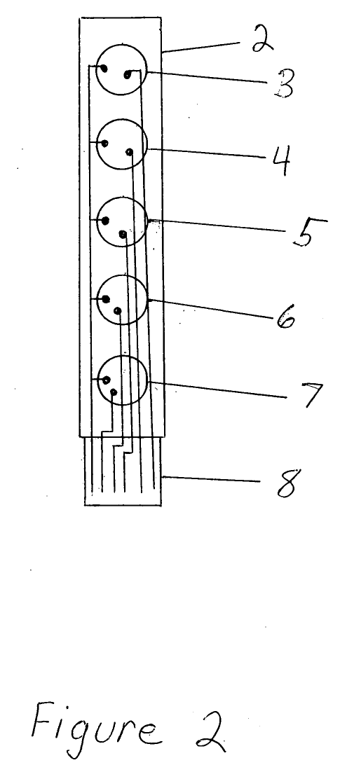

FIG. 2 shows a wiring diagram of L.E.D. lights 3, 4, 5, 6 and 7 in the remote colored light array base 2 to the female wire jack 8.

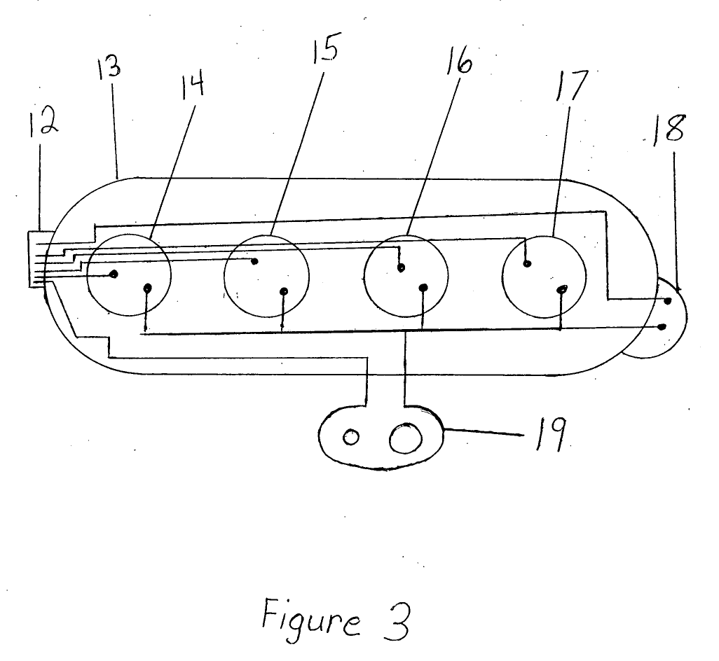

FIG. 3 shows a wiring diagram of the remote controller interactive buttons 14, 15, 16, 17, and 18 in the remote controller base 13 to the female wire jack 12 and the battery terminal 19.

### OPERATION

The operation of the present invention starts with the user wearing the colored light array by securing the ear hook around the ear. Holding the remote controller in one hand and placing fingers on interactive remote controller buttons 14, 15, 16, 17, and 18, the user can remotely control the colored light array in an interactive way by pushing down on the interactive remote controller buttons 14, 15, 16, 17, and 18 to correspondingly activate L.E.D. lights 3, 4, 5, 6, and 7 in the colored light array respectfully. A battery is connected to the battery terminal 19 in the remote controller base 13 to provide power. The manual interactive control gives the operator the opportunity to utilize a wearable array of colored lights.

### CONCLUSION

Thus the reader with see that the present invention will allow a user a way to remotely operate a colored light array that is worn. While the above description contains many spesifities, these should not be construed as limitations on the scope of the present invention, but rather as an exemplification of one preferred embodiment thereof. Many other variations are possible. For example, there can be different number of lights on an array. The securing means can be incorporated into other wearable devices such as eyeglasses, audio headset, or phone headsets. Accordingly, the scope of this invention should be determined not by the embodiment illustrated, but by the appended claims and their legal equivalents.

I claim:

1. A remote controlled wearable colored light signaling apparatus comprising of (a) a plurality of colored lights, (b) at least one first means for providing remote control of said plurality of colored lights, and (c) a second means for securing said plurality of colored lights to a user whereby allowing the user to wear and remotely control said plurality of colored lights.

2. The remote controlled wearable colored light signaling apparatus of claim 1 wherein said plurality of colored lights is a vertical array of blue, orange, green, yellow, and red colored lights respectfully from the top.

3. The remote controlled wearable colored light signaling apparatus of claim 1 wherein said second means for securing said plurality of colored lights is an ear hook that is worn around the ear.

4. The remote controlled wearable colored light signaling apparatus of claim 1 wherein said first means for providing remote control is a five button interactive handheld controller.
